(19) United States
(12) Patent Application Publication
(10) Pub. No.: US 2018/0326233 A1
(43) Pub. Date: Nov. 15, 2018

(54) AVALANCHE PROTECTION DEVICE

(71) Applicant: Mamaloha GmbH, Bern (CH)

(72) Inventors: Stefan Staub, Murzelen (CH); Thomas Roos, Ostermundigen (CH); Claudio Gallasch, Basel (CH)

(21) Appl. No.: 15/773,303

(22) PCT Filed: Nov. 4, 2016
(86) PCT No.: PCT/EP2016/076730

§ 371 Date: May 3, 2018

(30) Foreign Application Priority Data
Nov. 5, 2015 (CH) 1609/15

(51) Int. Cl. A62B 33/00; A45F 3/04; A62B 99/00

(52) U.S. Cl. CPC A62B 33/00; A62B 99/00; A45F 3/04

(57) ABSTRACT

The present invention relates to an avalanche protection device that includes an avalanche protection backpack with at least one inflatable buoyant airbag and a breathing system with a breathing housing. The breathing housing connects a one-way inhalation valve to an inhalation tube, and at least one intake port, and at least one ambient air suction zone. It also connects a one-way exhalation valve to an exhalation tube and a CO₂ exhalation region. A mouthpiece is provided on the breathing housing, which is able to be automatically pulled tightly onto the mouth of an avalanche victim by means of a facial airbag, by actuating a trigger handle. The invention additionally relates to a method for using such an avalanche protection device.

### TECHNICAL FIELD

This invention relates to the technical field of avalanche protection devices. Specifically this invention relates to an avalanche protection device comprising an avalanche protection backpack with an inflatable buoyant airbag and an improved breathing system for the lift, protection as well as the air supply of avalanche victims.

### STATE OF THE ART

The chances of rescuing alive a person buried by an avalanche is approximately 90% in the first quarter hour after being buried by the avalanche. However, the mortality rate increases significantly in the critical phase of the next 20 minutes, so that after 35 minutes only those approximately 35% who have free air passages survive. It is thereby to be emphasized in particular that those avalanche victims who have a hollow space in front of their mouth have significantly higher chances of survival. There is a risk of a horrifying death by asphyxiation if there is no breathing space in front of the mouth. The reasons therefor are usually closed or blocked respiratory passages and the lack of oxygen. With asphyxia moreover there is the basic problem that the re-inhalation of one's own CO₂-enriched respiratory air quickly causes the CO₂-content in the blood to rise, whereby breathing and thereby also circulation gradually come to a halt. If no immediate rescue by companions takes place, approximately 20 to 45 minutes pass by, on the average, before an organized rescue team arrives at the scene of the avalanche, which can already be too late for many avalanche victims.

Since the pioneering days of avalanche airbags in the 1980s, backpacks have existed, such as disclosed, for example, in the patent document AT 24407 T, with inflatable buoyant airbag, which allows avalanche victims to be lifted upwards in an avalanche, thanks to the additional volume.

In the past five years, moreover, diverse new approaches for avalanche airbag systems have come on the market, such as disclosed, for example, in the documents CH 701 630 A2, EP 2 485 810 A2 and US 2013/146175 A1. Thanks to their additional lift capacity, these solutions promise their users, in the case of an avalanche, to be able to prevent complete burial, whereby, after descent of the avalanche, one's head is supposed to be located above the blanket of snow.

The winter sports industry and the inventors' scene existing around this industry consequently place their main focus on preventing the burial of the head region of avalanche victims instead of viewing the problem in a more holistic or integrated way: Newer studies on the effectiveness of avalanche airbags clearly show that the avalanche airbags' effect on the mortality rate is significantly less than previously assumed and survival is not ensured by just additional lift.

The conclusion of an international study in 2014 on the effectiveness of the avalanche airbag clearly emphasizes that the inflated avalanche airbags prevent only about half of all deaths of persons having avalanche airbags (from 22% to 11%). The study identifies relevant factors which determine the chances of survival in the case of an avalanche, and these vary greatly; among them are the size of the avalanche, location of the victim when the avalanche was triggered, the character of the discharge of the avalanche and the critical burial depths related thereto, risk compensation, destruction of the airbag, malfunction of the airbag, more powerful force at triggering of the avalanche, training and familiarity with the avalanche protection devices. In particular the risk of a trough-shaped avalanche discharge (so-called terrain traps), the avalanche size and the risk at any time of subsequent avalanches form the parameters for the risk of a complete burial of the avalanche victim, despite buoyant airbags. It is also to be pointed out here that the majority of the avalanche airbag systems available on the market, in released state, interfere with the field of vision of their users in a dangerous way: in particular for those snowboarders, who “backside”, i.e. move sideways with their back to the slope and thereby trigger a slab avalanche. Those airbags which inflate over the head region of the user thereby make impossible the free view back toward the snow slab. Thus the instinctive flight of the snowboarder (at least “backside”) from the avalanche is made impossible.

In contrast to the prevalent avalanche lift systems are the avalanche breathing systems. The only capable solutions on the market which solve the problem of breathing under the blanket of snow are disclosed, on the one hand, in the documents EP 1 790 386 A2 as well as EP 2 620 181 A1. Both approaches prevent the CO₂ rise in the blood of the avalanche victim. With these systems ambient air is sucked in out of the blanket of snow and the exhaled air is blown to another place with the aid of a one-way fan while the ambient air is suctioned in.

The great weakness of both of these systems in practice is however that the person who finds himself in an avalanche situation has to be able to accomplish putting the nozzle-type mouthpiece into his mouth and has to keep this mouthpiece in his mouth the whole time while being buried by the avalanche. With triggering of an avalanche however an avalanche victim comes into a life-threatening situation and suddenly the person thereby enters into a state of shock. It is known that noradrenaline is thereby released which can impair the cognitive capabilities of this person, whereby situation-appropriate action can become difficult. Avalanche victims report that instinctively they try everything to keep their mouth as free as possible. In so doing, it is also reported by avalanche victims that they have taken the mouthpiece nozzle out of their mouths again on purpose during the avalanche. Also in view of the natural force which acts upon those buried by the avalanche during the descent of the avalanche and which thus can rip off the nozzle, the practical feasibility of these systems therefore seems rather doubtful.

In principle it can be noted that the avalanche breathing systems do not increase the chances of survival of an avalanche victim to the same extent that the lift systems do. The lift systems lead to a highly significant reduction in the mortality rate since the depth of burial with buoyant airbags in most cases is just so minimal that the buoyant airbags of the avalanche backpack are visible on the surface of the fallen avalanche mound, which also facilitates significantly the rescue by companions. However, depending upon the shape of the terrain and the size of the avalanche and the possible risk at any time of subsequent avalanches there exists nevertheless the risk that an avalanche victim with a lift system can be buried.

With newer lift systems such as e.g. disclosed in EP 2 604 318 A2, a buoyant airbag fills with ambient air and empties itself via a powerful battery-operated jet fan. The process of filling the airbag balloon can thereby be repeated multiple times. This state of the art has created a basis for suctioning ambient air out of the blanket of snow and then passing it on in a practical way. Unfortunately however, also with this solution, the focus is once again solely on the prevention of burial and the problem of a possible complete burial at any time is overlooked, which is why the problem of breathing in the case of a complete burial at any time is not solved.

A practice-relevant disadvantage which all avalanche backpack systems disclosed so far have must be especially brought to light here. If namely one person is buried in an avalanche and a second person must provide aid to his companion, this rescuing person is in danger of a subsequent avalanche. However this rescuing person must take off the avalanche backpack and thus the lift-capable and possibly breathing-capable protective system exactly then when it would most be needed only to be able to get to the avalanche transceiver and the shovel.

### DISCLOSURE OF INVENTION

The present invention has as its fundamental object to overcome these and further disadvantages of the state-of-the-art solutions. Specifically the object forming the basis for the present invention is to maximize the probability of survival of an avalanche victim, whereby the avalanche rescue team is given more time to be able to rescue avalanche victims alive.

This object is achieved through the features set forth in the independent claims. The especially advantageous embodiments of the invention are indicated in the subordinate claims as well as in the description or respectively in the drawings.

The advantage of the present invention over the existing state of the art is thereby multifaceted: On the one hand, also taken into consideration in the present invention is the problem of suffocation since despite the use of one or more buoyant airbags a complete burial can nevertheless take place with a probability that is not insignificant. A breathing system thereby serves as an aid, the mouthpiece of which can be pulled tightly on the mouth of the avalanche victim automatically with the aid of a facial airbag. A quick and forceful pulling movement on the trigger handle initiates the filling of the facial airbag and of the buoyant airbag or airbags. The filling of the facial airbag can thereby position the mouthpiece in front of the mouth of the avalanche victim; optionally a pretensioned spring, which jumps up, can also additionally serve this purpose. Once the mouthpiece is positioned, the complete filling of the facial airbag causes the mouthpiece to be pulled tightly on the mouth of the avalanche victim and since it is positioned in a way pulled tightly in front of the mouth it cannot come out of the mouth under any circumstances during the descent of the avalanche and the burial by the avalanche.

The lift capacity generated by the at least one buoyant airbag contained in the avalanche protection backpack makes it possible during the avalanche descent to remain above the blanket of snow or at least be swept in the upper part of the snow mass. If however the avalanche victim is nevertheless completely buried (i.e. head and therefore also air passages are located below the blanket of snow), for example owing to a trough-shaped discharge region of the avalanche or for instance because of a subsequent avalanche, the present invention, thanks to the automatically tightenable mouthpiece provided in addition to the at least one buoyant airbag, offers its user the possibility to breathe under the blanket of snow of an avalanche. Ambient air can thereby be suctioned out of the blanket of snow and the CO₂ arising from the breathing can be absorbed. A mouthpiece serves this purpose which is connected to the breathing housing. In the breathing housing two valves distinguish between the air which is breathed in and the air which is breathed out. The one-way inhalation valve obtains the ambient air via the inhalation tube and supplies itself with the ambient air contained in the snow by means of an intake port or suction nozzle in the ambient air suction zone. The one-way exhalation valve discharges the O₂-deficient and CO₂-rich exhaled air at an unproblematic place.

The so-called facial airbag offers various advantages necessary for survival: Its cut pattern or design shape is disposed in such a way that its filling (possible either with compressed air or with the ambient air suction fan) on the one hand tightens the mouthpiece on the head and in particular on the mouth of the avalanche victim and holds it in position and thereby also protects the air passages against entering snow and also offers furthermore trauma protection in the head and neck region of the avalanche victim. The facial airbag with its numerous advantages can find use in the avalanche protection backpack according to the invention. The facial airbag can be separate from the buoyant airbag or airbags or it can however be designed as a chamber connected together with the buoyant airbag or airbags. Thus, thanks to its useful cut pattern or design shape, a single airbag can fulfil the functions of lift, tightening of the mouthpiece on the mouth of the avalanche victim, protection of the air passages as well as trauma protection. It is also conceivable, however, for the facial airbag and the buoyant airbags to be designed separate from one another.

Provided furthermore on the avalanche protection backpack is a small, ejectable additional backpack: during the rescue of companions in the case of an avalanche the so-called “reduced carrying-strap backpack” makes possible the ejection of the small safety backpack in order to at least get to the avalanche transceiver and the avalanche shovel without thereby having to detract from the protective effect of the breathing-capable and lift-capable avalanche protection backpack system, since the risk of subsequent avalanches is very high during the rescue of companions.

Furthermore with the present invention there exists the possibility of using the avalanche protection device with the avalanche protection backpack and its entire inner volume, or parts thereof, as a gigantic intake port for the breathing system in order to satisfy the breathing requirements in this life-threatening situation of an avalanche descent.

According to a further embodiment, the use of a so-called ambient air suction fan is foreseen. This is a battery-operated fan which is able to suction ambient air out of the blanket of snow and expediently blow it out into the at least one buoyant airbag and the facial airbag. The inner volume of the ambient air suction fan can thereby serve as suction nozzle or intake port for the breathing system, whereby the inhalation tube is able to be connected directly to the ambient air suction fan housing or its airflow nozzle. The advantage thereby is that the ambient air in the buoyant airbag can also be used for breathing.

The present invention accordingly offers a multiplicity of advantages over existing solution approaches both for the breathing systems and for the lift systems. Since the mouthpiece is able to be pulled tightly on the mouth of the avalanche victim automatically, thus ensuring the physical connection of the lifesaving apparatus to the air passages of the avalanche victim, made impossible is, on the one hand, the entrance of snow into the air passages and, and, on the other hand, the loss of the mouthpiece in the avalanche.

The present invention offers in each of its described embodiments a higher probability of survival than all avalanche lift systems and avalanche breathing systems so far, and thus for many mountaineers, off-piste skiers, free riders and ski-touring enthusiasts it can be considered to be an expansion, essential for survival, of their equipment. Thus with the present invention a desirable new state of the art is created.

### BRIEF DESCRIPTION OF THE FIGURES

Described in the following are embodiments of the present invention by means of examples. The examples of the embodiments are illustrated by the following attached figures:

FIG. 1A shows schematically an avalanche victim with basic components of the avalanche protection device according to the invention in a semi-lateral view from behind;

FIG. 1B shows schematically an avalanche victim with basic components of the avalanche protection device according to the invention in a semi-lateral view from the front;

FIG. 10 shows schematically the pull-on mechanism of the breathing system of the avalanche protection device according to the invention with the facial airbag in a semi-lateral view from the front;

FIG. 2A shows schematically the reduced carrying-strap backpack of the avalanche protection device according to the invention in a front view;

FIG. 2B shows schematically the reduced carrying-strap backpack of the avalanche protection device in a rear view;

FIG. 3A shows schematically another embodiment of the reduced carrying-strap backpack of the avalanche protection device according to the invention in a side view;

FIG. 3B shows schematically a further embodiment of the reduced carrying-strap backpack of the avalanche protection device according to the invention in a side view; and

FIGS. 4A to 4I show schematically different detail drawings of an ambient air suction fan of the avalanche protection device according to the invention.

### DETAILED DESCRIPTION OF THE INVENTION

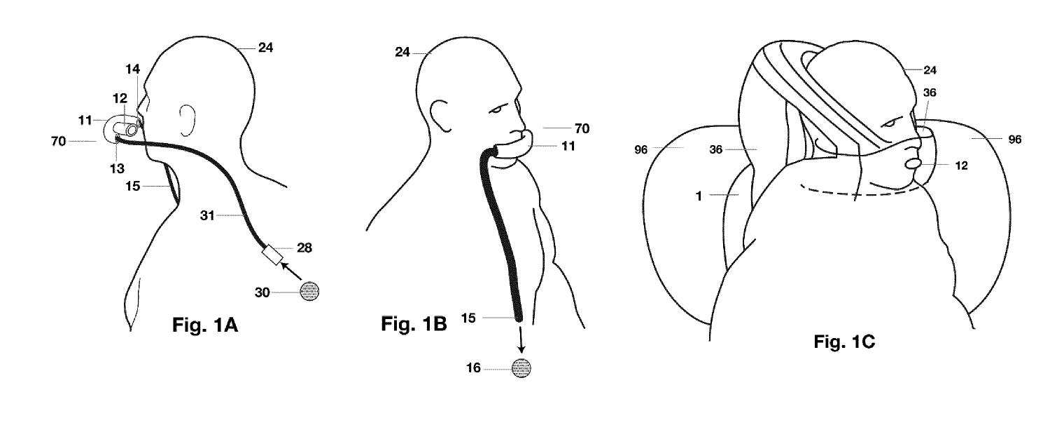

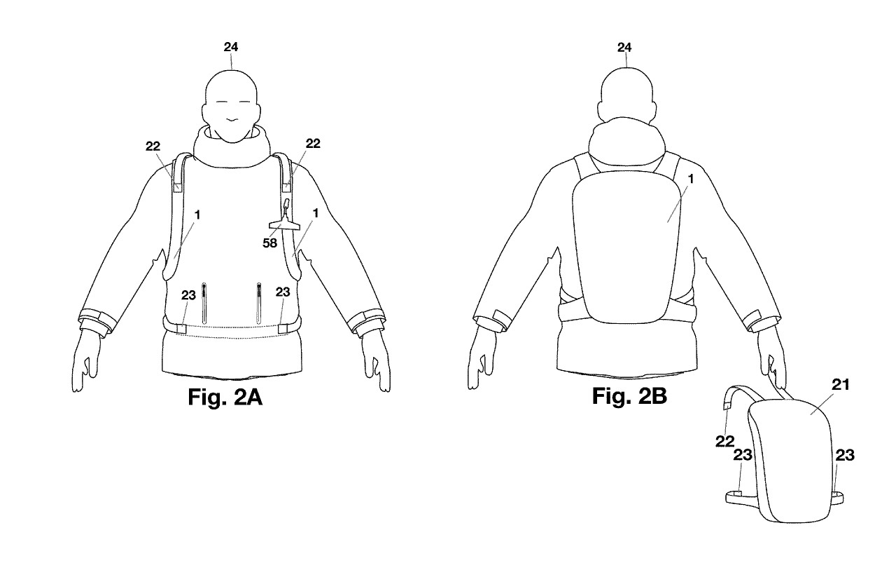

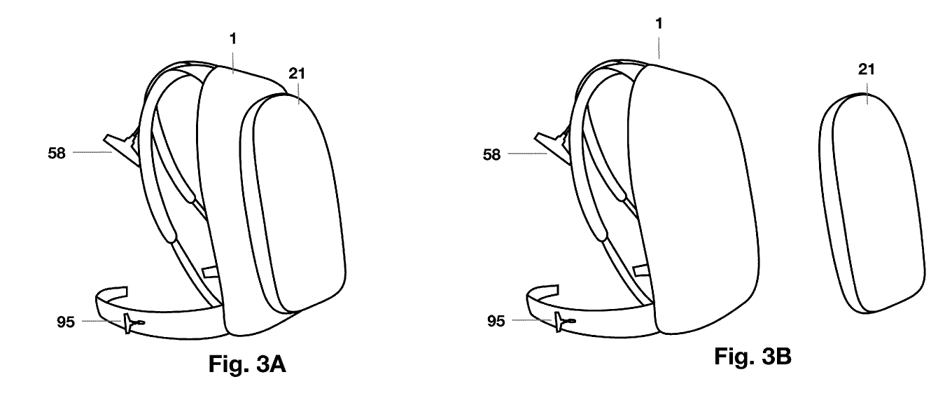

FIG. 1A shows a possible embodiment of the basic elements of the breathing system 70 of the avalanche protection device according to the invention. In addition to this breathing system, thanks to which breathing is possible also after an undesired burial, the avalanche protection device according to the invention also comprises an avalanche protection backpack with at least one inflatable buoyant airbag. The breathing system can however also be accommodated in an advantageous way in the avalanche protection backpack and can be pulled out as needed.

Via the mouthpiece 12 and the breathing housing 11 connected thereto, by means of the one-way inhalation valve 13, via an inhalation tube 31 and by means of at least one intake port or suction nozzle 28, the avalanche victim 24 can inhale from the ambient air suction zone 30 the ambient air contained in the blanket of snow between the snow crystals, and afterwards can breathe out into the CO₂-exhalation region 16, again via the mouthpiece 12 and the breathing housing 11, by means of the one-way exhalation valve 14 (see FIG. 1B) and the exhalation tube 15 connected thereto. Thus at all times fresh ambient air can be sucked in via the mouthpiece 12 and the breathing housing 11 and the O₂-deficient and CO₂-enriched exhaled air can be discharged again via the mouthpiece 12 and the breathing housing 11 with the aid of the one-way exhalation valve 14 to the CO₂-exhalation region 16 in the blanket of snow. The CO₂-exhalation region 16 is thereby ideally located as far as possible away from the ambient air suction zone 30 (as in FIG. 1A).

Another embodiment of the invention calls for also providing, in addition to the mouthpiece 12, a silicon lip (not depicted), which also covers the nose of the avalanche victim 24 and can thereby be tightly pulled to the mouth automatically and also to the nose with the aid of the facial airbag 36. This embodiment can be combined with each of the further mentioned embodiments of this invention.

FIG. 1B shows again possible embodiments of the basic elements of the breathing system 70 of the avalanche protection backpack according to the invention. The avalanche victim 24 thereby has the mouthpiece 12 in his mouth and breathes the ambient air, as described in FIG. 1A via the breathing housing 11 and discharges the exhaled air by means of the one-way exhalation valve 14 and the exhalation tube 15 connected thereto into the CO₂-exhalation region 16.

One possible embodiment foresees that the avalanche protection backpack 1 with its entire inner volume, or parts of its inner volume, is able to serve as a gigantic intake port 28. For this purpose a layer permeable for gases must be installed at least at one appropriate place of the avalanche protection backpack 1 in order to make use of the snow mass lying around the avalanche protection backpack 1 as ambient air suction zone 30. Furthermore the possibility presents itself of designing the so-called ambient air suction fan 26 (will be explained later) as intake port 28, which can support breathing in an active way and whose housing 27 can also serve the breathing system 70 as a gigantic intake port 28.

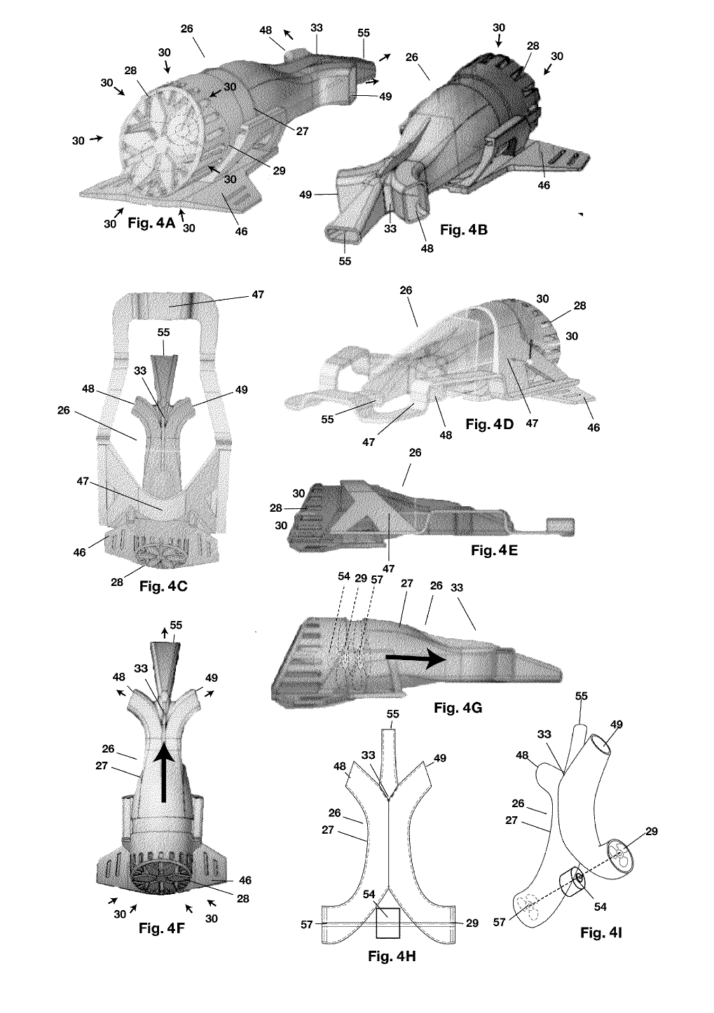

Visible in FIG. 10 is an important integral component of the breathing system 70: the facial airbag 36 makes it possible to tighten the mouthpiece 12 of the breathing system 70 automatically on the mouth of the avalanche victim 24: If the trigger handle 58 is actuated, optionally, a pretensioned spring 37 (not depicted) can release itself, which spring prior to the actuation is engaged in a spring engagement region 59 (not depicted), and owing to this actuation jumps up, whereby it brings the mouthpiece 12 into position in front of the mouth of the avalanche victim 24. Then the facial airbag 36, which deploys out of the upper part of the avalanche protection backpack 1 and its carrying strap, can be fully inflated and thereby position and tighten the mouthpiece 12 automatically on the mouth of the avalanche victim 24. The cut pattern or design shape of the facial airbag 36 is thereby advantageously produced in such a way that through its complete filling such a strong pressure develops on the facial airbag 36 running around the head, and in the neck region this facial airbag is shaped such that it pulls, on the one hand, around the head but also pulls tightly from the upper head region down to the mouthpiece 12. The cut pattern or design shape of the facial airbag 36 is thereby advantageously produced in such a way that it does not matter whether the avalanche victim 24 is wearing a helmet or not. According to another embodiment, it is possible for the facial airbag (36) to have one, two or more chambers. In any case, through the filling of the facial airbag 36, the mouthpiece 12 is automatically pulled tightly on the mouth of the avalanche victim 24. This offers the avalanche victim 24 trauma protection, important for survival, in the head and neck region. Through the actuation of the trigger handle 58 not only does the facial airbag 36 deploy, but also the buoyant airbag 96, which serves the avalanche victim 24 as a lifting body in the avalanche. This buoyant airbag 96 can, on the one hand, be designed as the same chamber as the facial airbag 36, but it can also be designed as a separate chamber. A possible embodiment foresees that the buoyant airbag 96 springs out of the avalanche protection backpack 1 by means of at least one pretensioned spring (not depicted) and thereby facilitates and accelerates the filling thereof. This embodiment is possible with the use of compressed air, and in particular is also able to be designed in an advantageous way with use of the ambient air suction fan 26.

Differences in the present invention with respect to the solution approaches disclosed in the patent documents EP 1 790 386 A2, EP 2 620 181 A1, U.S. Pat. No. 5,490,501 A as well as EP 0 998 959 A1 thereby become clear:

On the one hand, in the present invention, in the breathing housing 11 with its one-way inhalation valve 13 and the one-way exhalation valve 14 closer to the mouth of the avalanche victim 24, a distinction is made between inhaled and exhaled air, which offers the clear advantage that less enriched CO₂, or even none at all, will be breathed in again, which is not the case with the mentioned solution approaches. Moreover the solution approaches differ in that in the present invention the mouthpiece 12 is led automatically to the mouth of the avalanche victim 24 and is pulled tightly and the avalanche victim 24 does not have to take it manually into his mouth and hold on to it firmly while being buried by the avalanche since the facial airbag 36 in the present invention automatically tightens the mouthpiece 12 and holds it in place, and thereby not only ensures the physical connection to the air passages and to the lifesaving apparatus and thus enables breathing under the blanket of snow, but in addition also protects the air passages against entering snow and provides trauma protection, necessary for survival, in the head and neck region, thanks to the facial airbag 36. Furthermore the solution approaches differ in that in the present invention with one pull movement of the trigger handle 58, on the one hand, filling of the buoyant airbag 96 can be initiated and also the breathing system 70 with its mouthpiece 12 can be automatically pulled tightly onto the mouth of the avalanche victim 24. This has very important practice-relevant advantages since avalanche victims in the state of shock have very limited cognitive faculties. There have often been statements in this regard from avalanche victims who report that they have taken the mouthpiece by hand into their mouth, but have then pulled it out again and do not know anymore why they have taken it out. This limited cognitive capability is to be attributed to the increased proportion of (nor-) adrenaline whereby in the brain of the avalanche victim the so-called prefrontal cortex is switched off, and situation-appropriate and rational behavior thereby becomes almost impossible in the life-threatening situation of an avalanche. The present invention takes consideration of the limited faculties of avalanche victims 24, since lift and the possibility of breathing are made possible through one pull movement on the trigger handle 58, and thus elevates the state of the art in a desirable way.

One possible embodiment of the breathing system 70 foresees using the inner volume of the avalanche protection backpack 1 or parts of the inner volume as a gigantic intake port 28 (not depicted). This offers to the avalanche victim 24 the possibility of having available precisely during the avalanche burial sufficient air to breathe since the avalanche victim 24 can be in a state of shock, and, with (nor-) adrenaline and panic, has a greatly increased breathing capacity. This problem is not solved in a satisfactory way, neither theoretically nor in view of practice, in the above-mentioned solution approaches.

It is imaginable to combine the breathing system 70 according to the invention with its facial airbag 36 and the reduced carrying-strap backpack 21 (explained below) with popular lift systems. Moreover it is also conceivable for the facial airbag 36 to be able to be used to position and tighten a conventional breathing system at the mouth of the avalanche victim. Furthermore an embodiment is possible whereby the facial airbag 36 with the breathing system 70 according to the invention is also produced in the form of an avalanche protection garment such as, for example, a vest or jacket whereby the facial airbag 36 is incorporated into the collar construction and is able to be designed such that, through its filling, it can position and tighten the mouthpiece 12 on the mouth of the avalanche victim 24 whereby, once again, the air passages of the avalanche victim 24 are protected and whereby the facial airbag 36 also provides trauma protection in the head and neck region. All mentioned elements and subcomponents in the present invention can also be designed in the form of an avalanche protection garment and can furthermore be operated via conventional compressed air or also with use of the ambient air suction fan 26.

In FIGS. 2A and 2B the advantage of the reduced carrying-strap backpack 21 becomes clearly evident: on the one hand, as already explained, this makes possible, in the case of an avalanche, the ejection of the reduced carrying-strap backpack 21 from the avalanche protection backpack 1 and thereby facilitates the taking out of at least the avalanche transceiver and avalanche shovel without thereby losing the possibility of being able to trigger, when in danger, the lift system as well as being able to pull tightly the breathing system to the mouth. The reduced carrying-strap backpack 21 is accordingly designed as a unit attachable to, and ejectable from, the avalanche protection backpack 1, without having to detract from the avalanche protection backpack 1 and its protective effect. All avalanche lift systems and avalanche breathing systems known so far have not offered this possibility so far. The practice-relevance is thereby outstanding; if a ski-touring partner gets caught in an avalanche in open terrain and there is the risk of a subsequent avalanche, it is nevertheless possible to give aid to one's companion using the reduced carrying-strap backpack 21 and to take the avalanche transceiver and shovel out of the reduced carrying-strap backpack 21, without thereby having to detract from the lift and breathing-capable protection system (as is not the case with all prior solution approaches). Moreover the known avalanche protection systems have been worn so far over the backpack and the jacket, or are in part available also integrated into a backpack, but with all solutions so far these systems have to be taken off in order to perform rescue of a companion. Therefore the reduced carrying-strap backpack 21 is better suited to carrying the avalanche transceiver and the avalanche shovel than the previous solutions. Furthermore the advantage of the reduced carrying-strap backpack 21 will become clear and also why this has reduced carrying straps. The reduced carrying-strap backpack 21 can be ejected without having to take off the avalanche protection backpack 1 itself. Thus the reduced carrying-strap backpack 21 is removable without pulling one's arms through the carrying straps of the avalanche protection backpack 1 and thus the protective effect of the lift-capable and breathing-capable avalanche protection backpack 1 can remain on the body of the person who is rescuing a companion.

The reduced carrying-strap backpack 21 can be attachable with the aid of two upper backpack fasteners 22, two lower backpack fasteners 23, or by just one fastener encircling the waist region (not depicted), which is fixable in the navel region. For example, buckles or other expedient fastening possibilities can be attached on the avalanche protection backpack 1.

To be seen schematically in FIG. 3A is a further possible embodiment of the reduced carrying-strap backpack 21, which does not have any carrying straps at all. It can thereby be designed as ejectable backpack attachment unit for the carrying and ejection of at least one avalanche transceiver and avalanche shovel, and can be fixable on the avalanche protection backpack by means of remotely releasable (draw) bars, catches, quick-release clasps or buckles, quick-release pins, quick-release holders or quick-release hooks. It is clear to one skilled in the art that any expedient attachment and (remote) release possibility can serve the purpose here to eject the ejection element reduced carrying strap backpack 21 also without carrying straps. For example it can be ejected through the pulling movement of a remote ejection release handle (95) as can be seen in FIGS. 3A and 3B, which can be located in any expedient position on the avalanche protection backpack. Furthermore this embodiment can also be designed as an avalanche protection garment.

FIG. 4A to FIG. 4G show a possible embodiment of the ambient air suction fan, which can be used for the filling of the buoyant airbag 96 and of the facial airbag 36 and also can be used as an intake port 28 actively supporting breathing for breathing system 70.

A great advantage of the embodiment with the ambient air suction fan 26 is that the air in the buoyant airbag 96 can also be used for breathing, and breathing can be actively supported with the aid of the ambient air suction fan 26.

Thanks to its shape, the air flow nozzle 33 provides an optimal distribution of the ambient air flow volume generated by the propeller 29 in the ambient air suction fan housing 27. A possible embodiment thereby foresees the use of one, two or more propellers (not depicted), which can suck in the ambient air either axially or radially and blow it out. As soon as the propeller 29, optionally also a second propeller 57, blow the ambient air out into the air flow nozzle 33, most of the ambient air flow volume thereby reaches the facial airbag 36, thanks to the shape of the respective channels of the air flow nozzle 33, depending upon the embodiment, first via the middle air flow channel 55, but also reaches immediately the buoyant airbag 96 via the left air flow channel 48 and the right air flow channel 49. As soon as this buoyant airbag is completely inflated and offers the avalanche victim 24 a lift, most of the flow volume in the air flow nozzle 33 automatically finds its way via the middle air flow channel 55, which has a smaller outlet than the other channels. A strong ambient air volume flow thereby escapes via this middle air flow channel 55, which is used, on the one hand, in order to keep the facial airbag 36 completely inflated, as well as via the inhalation tube 31 in the breathing housing 11. In the embodiment with the ambient air suction fan 26 as active support for the breathing system 70, the inhalation tube 31 can be directly connected at any desired place either to the ambient air suction fan housing 27 or on the air flow nozzle 33. The ambient air suction fan 26 can thereby directly support breathing whereby its inner volume serves as a big intake port 28, via which breathing can still take place even with depleted battery 51 (not depicted). It is thereby possible at any desired place in the ambient air suction fan 26 to design at least one (sensor-controlled) one-way valve (not depicted) in such a way that the blown-out air from the buoyant airbag 96 and from the facial airbag 36 cannot flow back into the ambient air suction fan 26, so that at least the ambient air in the buoyant airbag 96 can be used for breathing via the breathing system 70. Furthermore connected to the middle air flow channel 55 can be either two connections (not depicted) or one connection (not depicted), which open or bisect in order, on the one hand, to inflate the facial airbag 36 and to allow the excess ambient air to flow into the breathing housing 11.

If, via the inhalation tube 31, more air is sucked into the breathing housing 11 than via the mouthpiece 12, this air flows via the one-way exhalation valve 14 and thereby via the exhalation tube 15 into the CO₂-exhalation region 16, or optionally it can also flow back to the ambient air suction fan 26.

Immediately after actuation of the trigger handle 58 a large amount of ambient air can be sucked in via the mouthpiece 12 by means of the breathing housing 11, which is expedient and necessary especially during the avalanche descent since the avalanche victim 24 in a state of shock with a lot of panic and adrenaline needs a greatly increased air volume for breathing. It is pointed out here that, for example, the solution disclosed in the document EP 1 790 386 A2 unfortunately provides an insufficient volume of air for breathing with greatly increased air volume.

Moreover it can be seen in FIG. 4A to FIG. 4G that there can be at least one motor 54 in the housing of the ambient air suction fan 27, whereby a powerful electromotor can be used which turns at least one propeller 29, but also an optional second propeller 57, either radially or axially, which, for their part, blow ambient air via the intake port 28 from the ambient air suction zone 30 through the ambient air suction fan housing 27 into an air flow nozzle 33. The arrows in the respective pictures thereby indicate the air flow direction.

Furthermore it is to be noted that, thanks to the ambient air suction fan 26, unlike e.g.in EP 2 604 318 A2, ambient air at any time is able to flow in just one direction and these solution approaches differ furthermore in that with the aid of the inhalation tube 31, which can be connected directly to the ambient air suction fan 26 or its air flow nozzle 33, on the one hand the lift and on the other hand breathing can be actively supported.

Furthermore the solution approaches differ in that in the present invention the air flow nozzle 33 allows the ambient air to flow in three (or optionally in one, two, three, four, five, six or more—not depicted) different channels so that the left air flow channel 48, the right air flow channel 49 and the middle air flow channel 55 undertake the further allocation of the sucked-in ambient air. In one possible embodiment, as can be seen in FIG. 5A, the ambient air flows via the air flow nozzle 33 from the left air flow channel 48 and from the right air flow channel 49 into the buoyant airbag 96 and from the middle air flow channel 55, as already explained, into the facial airbag 36 and, thanks to the direct connection of the inhalation tube 31 to the ambient air suction fan 26, also into the breathing housing 11, and is thereby able to be sucked in by the mouthpiece 12.

The respective connections of the air flow channels to the respective airbags thereby foresee appropriate tube-type connections (not depicted). An embodiment is thereby also conceivable in which electronically controlled valves (previously called one-way valves, not depicted) provide the pressure (ambient air in the buoyant airbag) after a predetermined amount of time, for example after 3 minutes, to the avalanche victim 24. It is thereby clear to one skilled in the art that at each expedient place one-way valves (not depicted), sensors (not depicted) as well as diverse valves (not depicted) can be connected at diverse appropriate places of the present invention, for example on the air flow nozzle 33 or on the buoyant airbag, for the optimal allocation of the air flow generated by the ambient air suction fan 26, so that first the buoyant airbag 96 and the facial airbag 36 optimally unfold and generate lift, and then after (nevertheless possible complete) burial of the avalanche victim 24 the remaining capacity of the battery 51 can be used to allow the maximal volume of ambient air to flow into the breathing housing 11, and thereby be able to be sucked in by the mouthpiece 12.

A further embodiment furthermore allows sensor-controlled valves (not depicted) to control the allocation of the ambient air, for example via the middle air flow channel 55 into the inhalation tube 31 and the breathing housing 11, and thereby be able to be sucked in by the mouthpiece 12.

The carrier housing 47 protects the ambient air suction fan 26 against damage and pressure. The carrier housing 47 furthermore serves the purpose of allowing the buoyant airbag 96 to unfold optimally and have the free space necessary to do so. The air flow nozzle 33 can moreover be connected to the ambient air suction fan housing 27 in such a way that an articulation (not depicted) thereby makes possible movability of the ambient air suction fan housing 27 and thus improved ergonomics. Also an appropriate padding (not depicted), which can be embedded between the elements of the ambient air suction fan 26 and the avalanche protection backpack 1 shown in FIG. 4A to FIG. 4I can offer sufficient protection around the avalanche victim 24 against blows and pressure points in the back and spinal column region.

Furthermore another possible embodiment of the ambient air suction fan 26 is shown in FIG. 4H and FIG. 4I, whereby the driving shaft of the motor 54 turns two propellers at the same time, the propeller 29 as well as the propeller 57. In this embodiment two intake ports 28 as well as two ambient air suction zones 30 are thereby provided.

1. An avalanche protection device, comprising:
an avalanche protection backpack with at least one inflatable buoyant airbag and
a breathing system with a breathing housing which
connects a one-way inhalation valve to an inhalation tube, and at least one intake port, and at least one ambient air suction zone, and which
connects a one-way exhalation valve to an exhalation tube and a CO₂ exhalation region,
wherein a mouthpiece is provided on the breathing housing, whereby the mouthpiece is able to be automatically pulled tightly onto the mouth of an avalanche victim by means of a facial airbag by actuating a trigger handle.

2. The avalanche protection device according to claim 1, wherein through actuation of the trigger handle the at least one buoyant airbag and the facial airbag are inflatable, whereby the mouthpiece is positionable and is able to be pulled tightly on the mouth of the avalanche victim.

3. The avalanche protection device according to claim 1, wherein the facial airbag and the at least one buoyant airbag are made in such a way that they are designed together as an inflatable chamber or are designed as at least two chambers separated from one another.

4. The avalanche protection device according to claim 1, wherein an inner volume of the avalanche protection backpack or parts of the inner volume of the avalanche protection backpack are constructed in such a way that it/they are designed as said at least one intake port for the breathing system.

5. The avalanche protection device according to claim 1, wherein the facial airbag is designed in such a way that entrance of snow into air passages of the avalanche victim is able to be prevented, said facial airbag further being designed as trauma protection for the avalanche victim in the head and neck region.

6. The avalanche protection device according to claim 1, further comprising a reduced carrying-strap backpack for carrying at least one avalanche shovel and an avalanche transceiver, the reduced carrying-strap backpack being attachable to the avalanche protection backpack in such a way that the avalanche shovel and avalanche transceiver are ejectable without thereby losing protection of the avalanche protection backpack.

7. The avalanche protection device according to claim 6, the reduced carrying-strap backpack being removable from the avalanche protection backpack without having to pull the avalanche victim's arms through carrying straps of the reduced carrying-strap backpack, and/or the reduced carrying-strap backpack being ejectable via a remote trigger handle.

8. The avalanche protection device according to claim 1, wherein the at least one buoyant airbag is designed in a way able to pop out of the avalanche protection backpack with the aid of at least one pretensioned spring.

9. The avalanche protection device according to claim 1, wherein the mouthpiece is disposed in a breathing mask configured to encompass the mouth and nose of the avalanche victim and/or is designed with one or more breathing holes.

10. The avalanche protection device according to claim 1, wherein provided for filling the facial airbag and the at least one buoyant airbag are a container with conventional compressed air and/or an ambient air suction fan, whereby the ambient air suction fan is connected to said inhalation tube and is designed as said at least one intake port for the breathing system.

11. A method for avalanche protection, comprising actuation of the trigger handle of the avalanche protection device according to claim 1, the mouthpiece is thereof being thereby able to be pulled tightly on the mouth of the avalanche victim-, and/or an ambient air suction fan and/or a container with conventional compressed air are able to be activated and/or the at least one buoyant airbag and/or the facial airbag are able to be inflated.
